(19) United States
(12) Patent Application Publication
(10) Pub. No.: US 2019/0070067 A1
(43) Pub. Date: Mar. 7, 2019

(54) Stress Ball Massaging Device

(71) Applicant: Jeffrey Marcu, Highlands Ranch, CO (US)

(72) Inventor: Jeffrey Marcu, Highlands Ranch, CO (US)

(21) Appl. No.: 16/115,270

(22) Filed: Aug. 28, 2018

Related U.S. Application Data
(60) Provisional application No. 62/553,283, filed on Sep. 1, 2017.

(51) Int. Cl. A61H 15/00; A63B 37/08

(52) U.S. Cl. CPC A61H 15/0092; A61H 2015/0042; A63B 2037/085; A63B 37/08

(57) ABSTRACT

A generally ovoid handheld massager with a massage wheel and a thick gel-like elastomeric material covering the gripping portion of the ovoid body is described. The gel material allows a user to squeeze the body in his/her hand much like a stress ball. Additionally, one or more ovular indentations are provided into the ovoid body permitting a user to rest his/her thumb or other finger therein during use.

### RELATED APPLICATIONS

This application claims priority to and incorporates fully by reference U.S. provisional patent application No. 62/553,283 entitled Combination Wheeled Massager and Stress Relief Device filed on Sep. 1, 2017 and having the same inventor.

### BACKGROUND

Handheld massagers incorporating one or more wheels that one roll over a user's body or the body of another are well known. Typically, they comprise a rigid structure to be gripped in the hand(s) to which the wheels are attached either directly or by way of axles.

Stress balls are also known. Stress balls typically comprise a malleable ball which can be squeezed or manipulated by a hand and fingers ostensibly to relive stress and/or muscle tension. At least two basic types are known: a bean bag type; and an elastomeric type. The bean bag type typically comprises a thin elastomeric cover containing particulate (such as sand, gel or beads). The elastomeric type often comprises a squeezable resilient foam or rubber-like material that rebounds back to its original shape once squeezing has stopped.

### BRIEF DESCRIPTION OF THE DRAWINGS

FIG. 1 is a first perspective view of a massaging device according to one embodiment of the present invention.

FIG. 2 is a second perspective view of the massaging device according to one embodiment of the present invention.

FIG. 3 is a left side view of the massaging device according to one embodiment of the present invention.

FIG. 4 is a right side view of the massaging device according to one embodiment of the present invention.

FIG. 5 is a top side view of the massaging device according to one embodiment of the present invention.

FIG. 6 is a bottom side view of the massaging device according to one embodiment of the present invention.

FIG. 7 is a back side view of the massaging device according to one embodiment of the present invention.

FIG. 8 is a front side view of the massaging device according to one embodiment of the present invention.

FIG. 9 is an exploded perspective view of the massaging device according to one embodiment of the present invention.

FIG. 10 is a perspective view of a wheel of the massaging device according to one embodiment of the present invention.

FIG. 11 is a perspective top side view of a rigid body member of the massaging device according to one embodiment of the present invention.

FIG. 12 is a perspective bottom side view of the rigid body member of the massaging device according to one embodiment of the present invention.

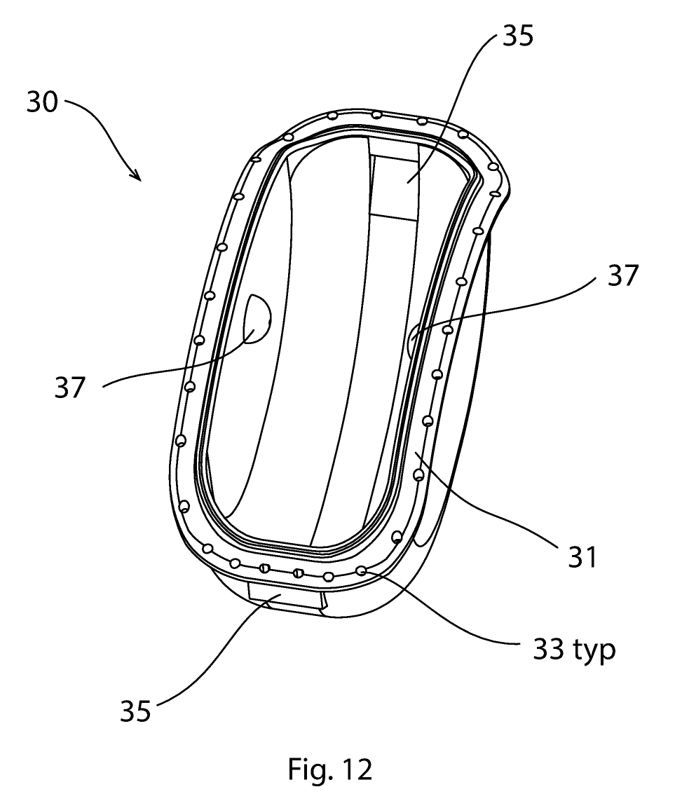

FIG. 13 is a perspective view of a gel egg member of the massaging device according to one embodiment of the present invention.

### DETAILED DESCRIPTION

Embodiments of the present invention comprise a handheld massage device incorporating a massage wheel that has a resilient and compliant thick exterior skin. The device permits a person holding the massager to alternatingly tighten and loosen his/her grip on the device with the cover resiliently deforming to help the person to relieve stress in a manner substantially similar to that used on a stress ball. The person can also simultaneously or separately roll the wheel over the extremities of him or herself or those of another to provide a massage.

In embodiments, the wheel is made of a harder material than the gel-like skin and can include nubbins or other surface topography to provide the person against whom the wheel is being rolled an enjoyable and/or effective massage. The wheel is typically rotatably received in a rigid body over which the gel-like skin is molded or otherwise attached.

In some embodiments, the device is generally ovoid and sized to fit comfortably within the grip of a hand. Differently sized devices can be provided for people having differently sized hands. Embodiments can also include indentations or divots that may be either generally circular or ovular in which to receive a user's thumb or other finger to assist in gripping the device and to position the hand in the ideal position for one or both of rolling the massager over a body and alternatingly squeezing and relaxing the hand's grip on the device.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### An Embodiment of a Stress Ball Massaging Device

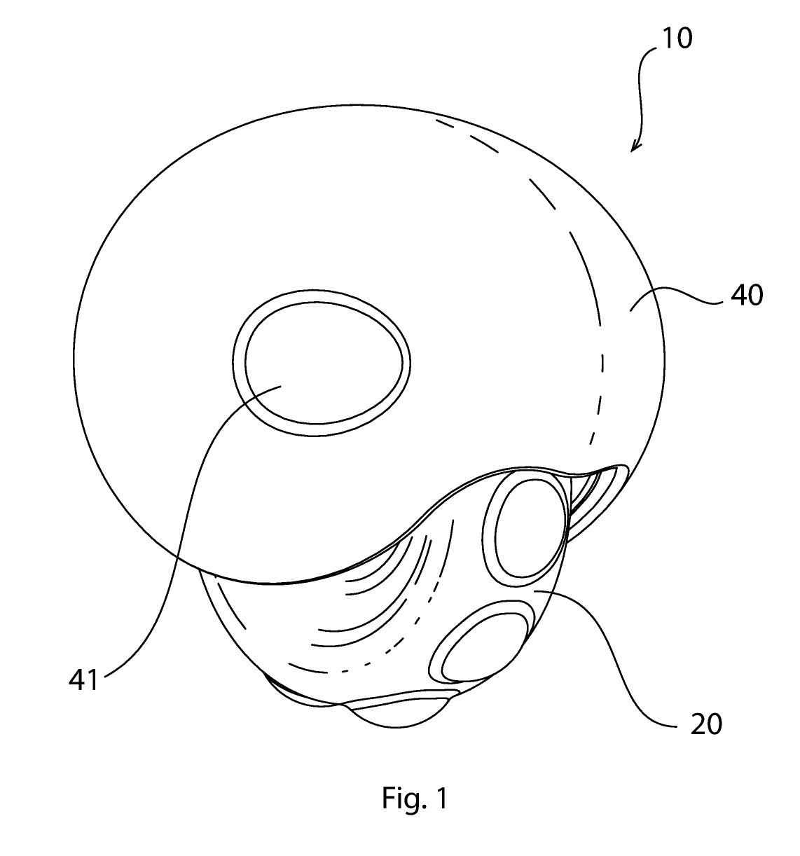

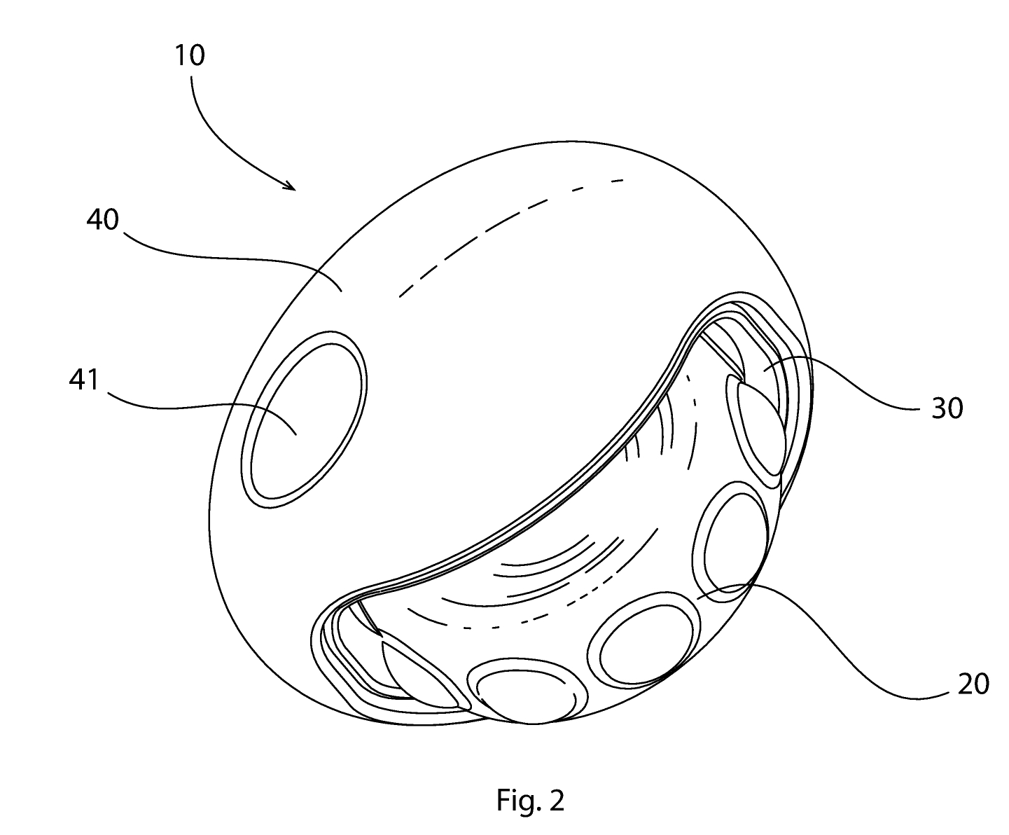

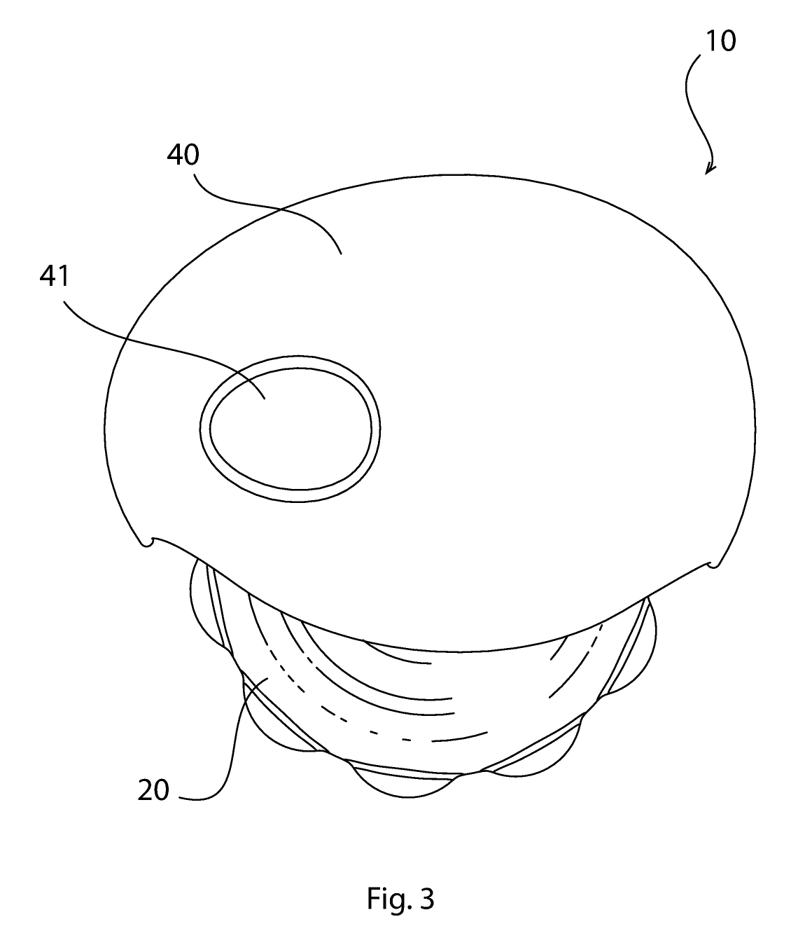

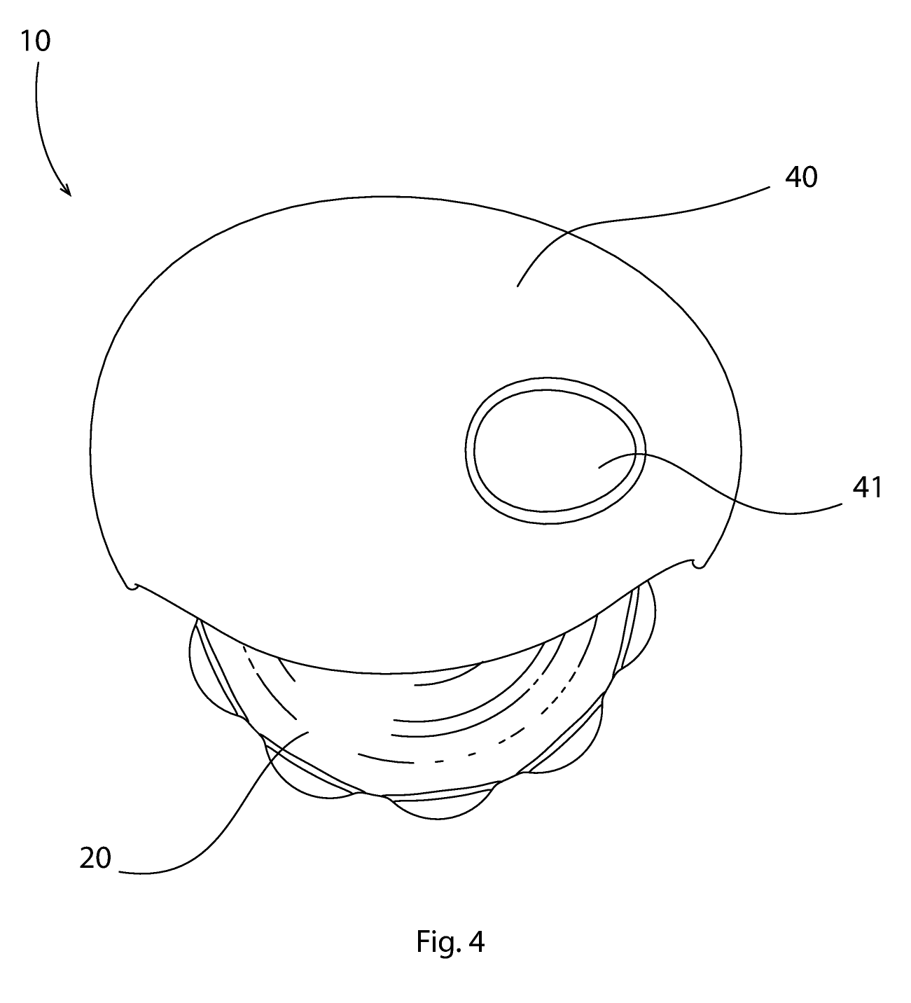

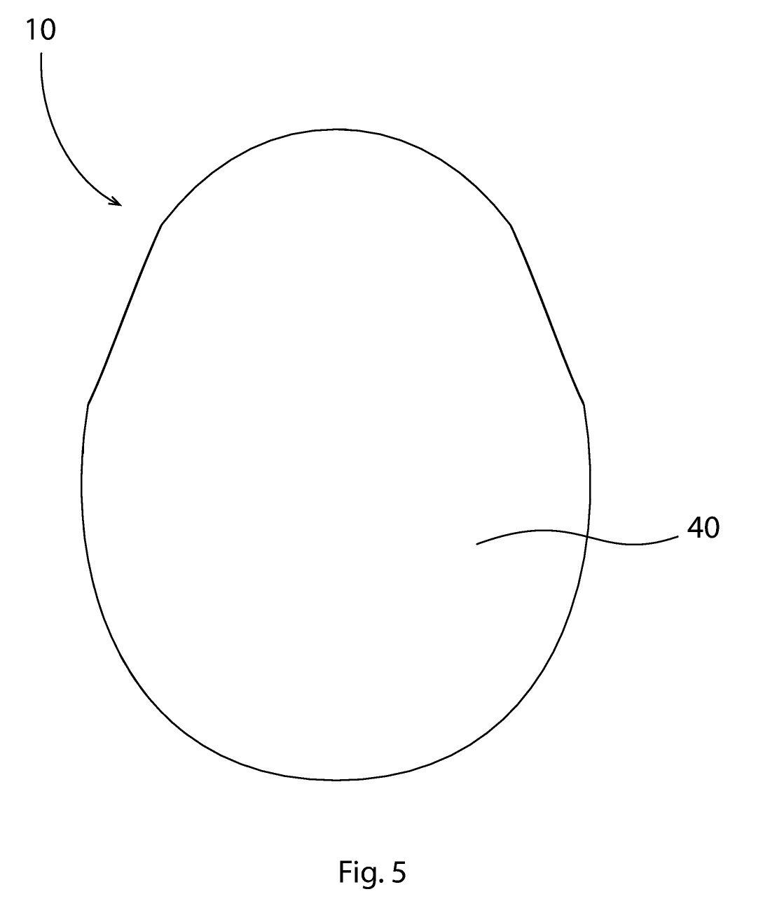

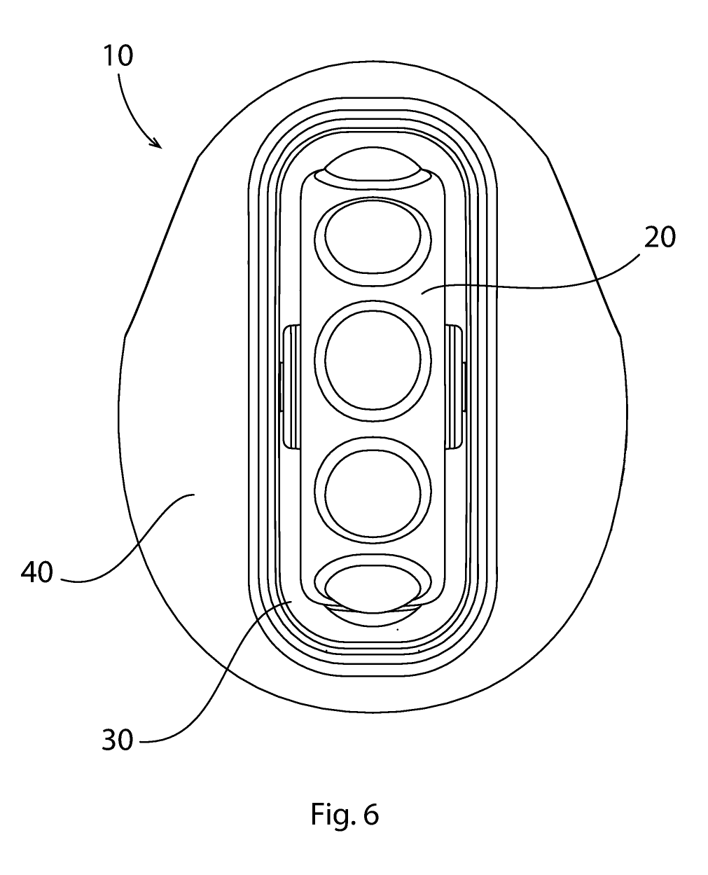

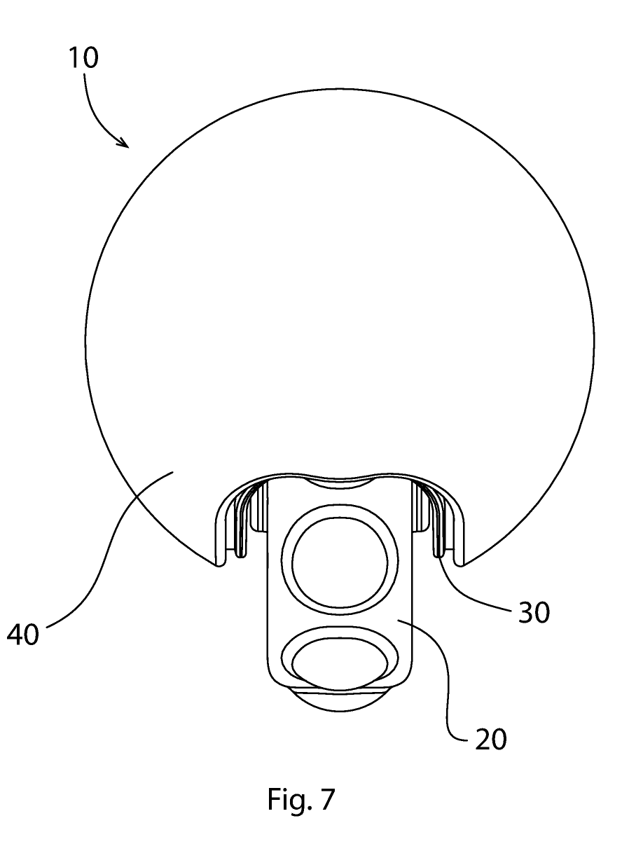

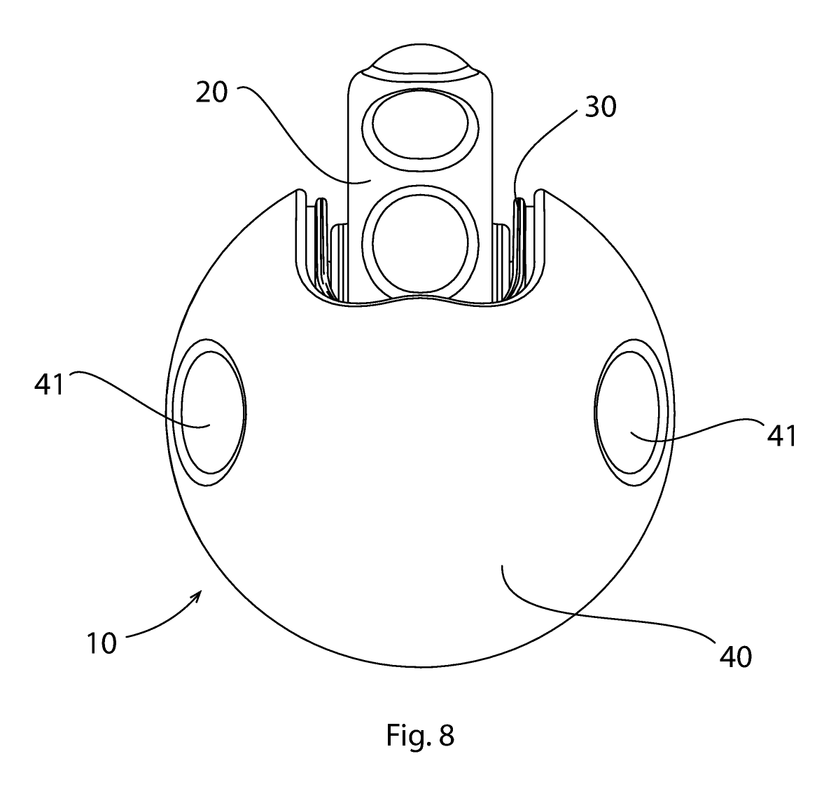

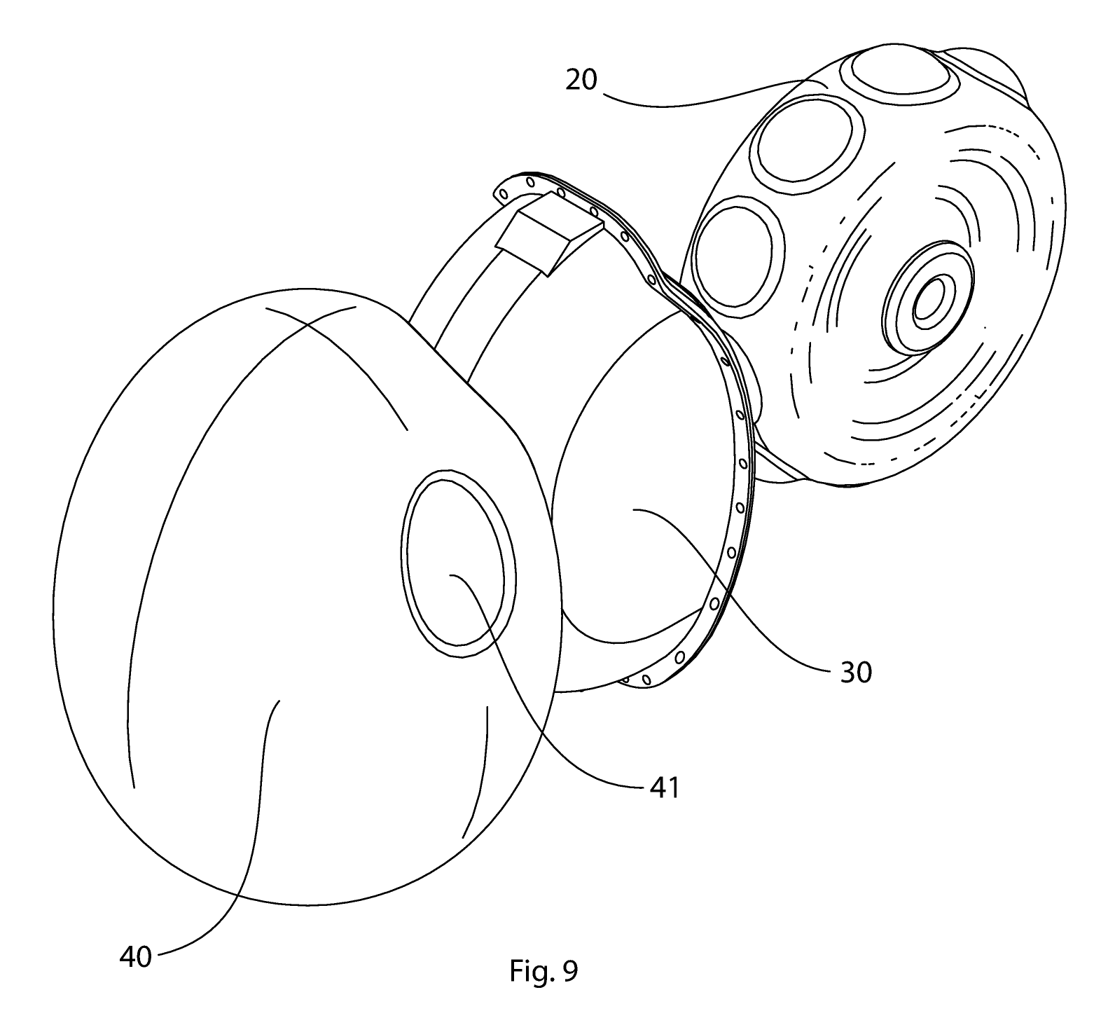

FIGS. 1-9 provide various views of an embodiment of a stress ball massaging device 10. As best shown in the exploded view of FIG. 9, the device typically comprises three components: a massage wheel 20; a rigid body 30 into which the wheel is rotatably received; and a thick resilient gel-like elastomeric cover 40. The wheel includes an axle hole 23 centered about the wheel's center axis that snappily receive a pair of aligned opposing generally hemispherical axle protrusions 37 located in a body cavity of the rigid body. The gel-like elastomeric cover in turn is molded over the exterior surface of the body cavity. The illustrated embodiment is about 3.1 inches long, 2.4 inches wide, and 3.1 inches tall including the wheel although the size can vary in other embodiments.

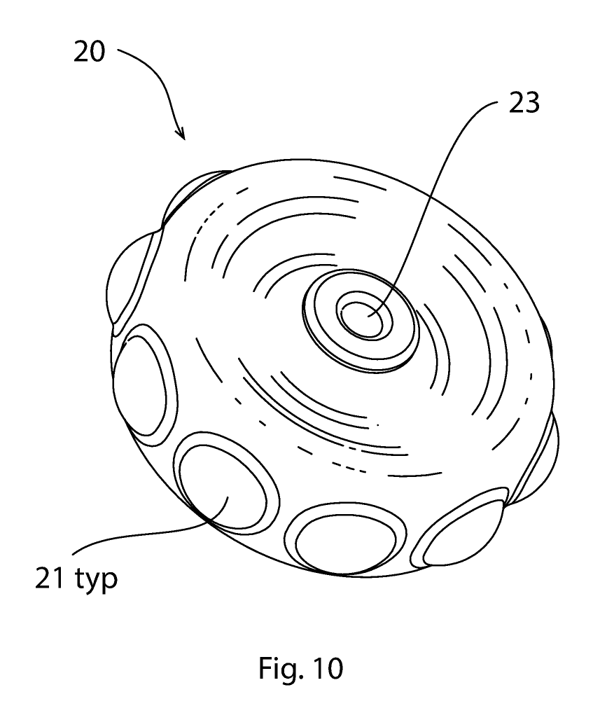

The massage wheel is best shown in FIG. 10 and is typically comprised of a generally rigid plastic, such as but not limited to polypropylene, and includes the aforementioned axles hole 23 passing through its center axis. Variations are also contemplated having a wheel comprised of softer semi-rigid materials that offer a bit of compliance during a massage. In at least one embodiment the wheel is about 2.3 inches in diameter and about 0.9 inches wide although deviations from these dimensions are contemplated.

The circumferential surface of the wheel 20 which comes into intimate contact with the body of a person being massaged may include a surface topography designed and configured to enhance the massage experience. As shown in the illustrated wheel a plurality of protruding nubbins 21 are circumferentially-spaced are provided on the circumferential surface. The type and configurations of the wheel's surface features can vary significantly depending on a particular design and the desired massaging experience.

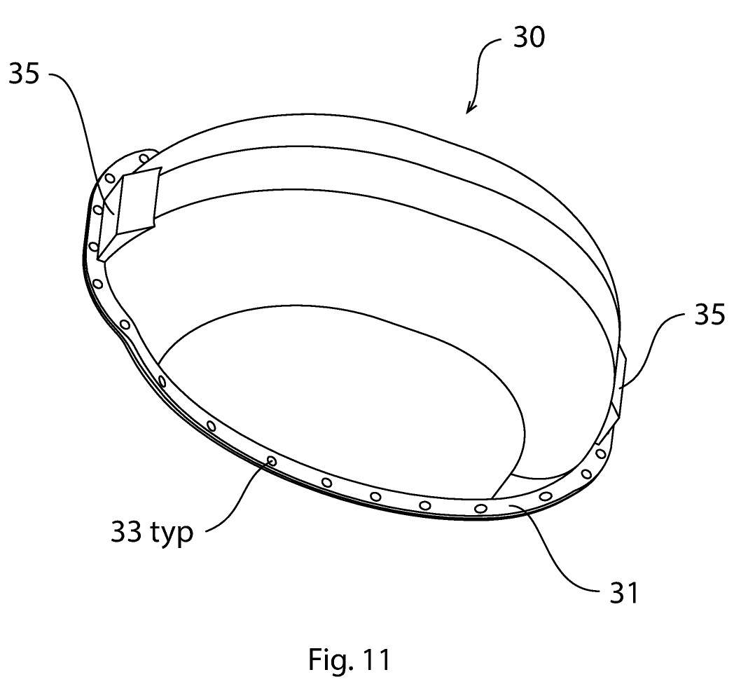

The rigid body 30 is best shown in FIGS. 11 & 12 and is typically comprised of polypropylene although other plastics can be utilized. As can be seen, the body forms a cavity or wheel well into which the wheel is received and rotatably secured by way of the opposing axle protrusions 37. As can be seen in the various figures more than half the wheel is received in the wheel well. The side walls flex sufficiently when the wheel is inserted into the cavity to permit the axle protrusions to be received in the wheel's axle hole but once snappily received the wheel is not easily removed there from without the application of substantial force.

The bottom edge of the body and its cavity include an outwardly-extending circumscribing flange 31 The circumscribing flange includes a plurality of small holes 33 spaced about it and extending through it. Further, outwardly-extending front and rear protrusions 35 are provided on the front and back sides of the body as can best be seen in FIG. 11. The small holes and the protrusions help secure the over-molded elastomeric cover to the body when the cover is formed on the body.

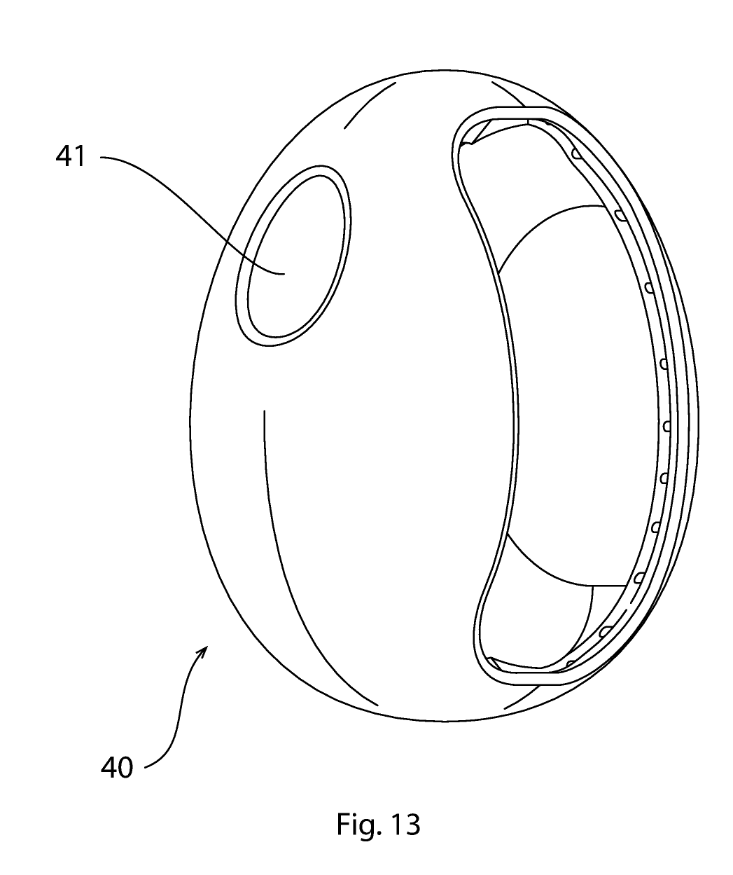

The gel-like elastomeric cover 40 is seen by itself in FIG. 13. The cover, however, is molded in place on top of and over the rigid body 30 and as such the interior configuration of the cover is based on the corresponding features of the rigid body. For instance, the indentations on the front and back sides of the cover cavity correspond to the front and rear protrusions of the exterior surface of the rigid body. Additionally, the cover when being molded seeps into the plurality of small holes 33 spaced on the circumscribing flange 31. When over-molded on top of the rigid body, the cover material both adhesively bonds to the surface of the body and mechanically interlocks in place by way of the aforementioned features.

The exterior surface of the cover is substantially ovoid with an ovular indentations 41 being provided on each of the left and right sides of the cover's exterior proximate the front end thereof. These indentations provide a place for a user to place his/her thumb and another finger to more securely hold the device while performing a massage. The shape, placement and configuration of the indentations can vary in other embodiments.

In one embodiment the cover 40 comprises a solid thermoplastic polyurethane material that is injection molded over the rigid body. Typically, the gel-like material has a Shore A hardness of about 0-10 although the hardness can vary from softer to harder, such as from a Shore 00 value of 40 to a Shore A hardness value of 30. The relative softness and compliance of the cover as well as its thickness permit a holder to squeeze and release the device much in the same manner he/she might when kneading a stress ball. In some instances, a user may knead the device through its cover while simultaneously rolling the massage wheel on his/her skin or the skin of another person. In other instances, the user may knead the device distinctly and apart from performing a massage. The cover can be made of other materials that are also elastomeric and resilient such as, but not limited to, solid thermosetting polyurethane, silicone or latex, as well as open and closed cell foams made of the same or similar materials.

The gel-like soft but resilient consistency of the cover material along with the relative thickness of the cover over the rigid body make it suitable and effective when used as a stress ball replacement. As can be appreciated the thickness of one embodiment of the cover varies from a low of about 9 mm on the front side of the device to a maximum of about 17 mm at the thickest part of the “egg” proximately halfway along its length. Typically, the thickness of the gel cover where typically gripped is about 12 mm or greater.

The illustrated embodiment has three only the described components but variations and other embodiments may comprise additional components or elements. For instance, in one variation a separate axle can be provided. In yet other variations a multi-piece body or wheel can specified. For example, a tread or tire can be provided on the circumferential exterior of the wheel that is made of a compliant material to provide a massage experience that is different from a device utilizing a wholly rigid wheel or wheel assembly. As can be appreciated, however, the three piece device will typically be more cost effective to produce than a device having more pieces.

The egg-shape of the illustrated embodiment is configured to be more comfortably and more securely held in the hand than other shapes, such as a sphere; however, embodiments of other shapes are contemplated, such as a ergonomically-configured cover having indentations for each finger and having an exterior shape substantially similar to the interior shape of a person's hand when griping an object.

### Methods of Using the Stress Ball Massaging Device

Embodiments of the massaging device 10 can be used in a manner similar to many hand held massage devices already on the market, but additionally it can be used to provide the person gripping the device as a means to exercise his/her hand either separately or while performing a massage.

In one use, a person holding the device massages the body of another person. While massaging the other person, the person applies pressure to the device resiliently deforming the cover and then relaxes his/her hand in an alternating fashion.

In another similar use, the person holding the device massages him or herself while kneading the device with the hand holding the device.

In yet another use, the user simply picks up the device and uses the device as a stress ball without performing a massage on him or herself or anyone else.

Other uses as would be obvious to one or ordinary skill in the art to which the invention pertains are also contemplated.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention. For instance, in one variation, the axle protrusions can be provided on the wheel; whereas, the corresponding holes can be provided in the rigid body.

I claim:

1. A handheld massage device comprising:
a body having an exterior surface and forming a cavity with an interior surface, the cavity having opposing left and right sides;
a wheel, the wheel rotatably coupled to the left and right sides and at least partially contained within the cavity; and
an elastomeric cover substantially covering the exterior surface.

2. The handheld massage device of claim 1, wherein the cover is generally ovoid-shaped.

3. The handheld massage device of claim 1, wherein the cover includes at least one fingertip-sized indentation on at least one of the left and right side of the device generally proximate a front end thereof.

4. The handheld massage device of claim 2, wherein the cover includes at least one fingertip-sized indentation on at least one of the left and right side of the device generally proximate a front end thereof.

5. The handheld massage device of claim 1 wherein the device consists essentially of the body, the wheel and the elastomeric cover.

6. The handheld massage device of claim 1 wherein the elastomeric cover has a Shore 00 harness value of 40 to a Shore A hardness value of 30.

7. The handheld massage device of claim 4 wherein the elastomeric cover has a Shore 00 harness value of 40 to a Shore A hardness value of 30.

8. The handheld massage device of claim 1 wherein the elastomeric cover has a Shore A hardness of about 0-10.

9. The handheld massage device of claim 1 wherein the elastomeric cover is overmolded on to the body.

10. The handheld massage device of claim 1, wherein the elastomeric cover has a thickness of 8-20 mm.

11. The handheld massage device of claim 1, wherein the elastomeric cover has an average thickness of at least 10 mm.

12. The handheld massage device of claim 7, wherein the elastomeric cover has an average thickness of at least 10 mm.

13. The handheld massager of claim 1, wherein an axle protrusion extends from each of the left and right sides and are received in an axle bore of the wheel.

14. The handheld massager of claim 1, wherein the body further includes a flange extending around the exterior surface proximate a bottom edge of the cavity, the flange including a plurality of holes distributed thereon.

15. The handheld massager of claim 1, wherein the wheel includes a circumferential surface, the circumferential surface including a plurality of hemispherical nubbins distributed there around.

16. The handheld massager of claim 1, wherein elastomeric cover is comprised of thermoplastic polyurethane.

17. A handheld massage device comprising:
a substantially rigid body having an exterior surface and forming a cavity with an interior surface, the cavity having opposing left and right sides;
a wheel, the wheel rotatably coupled to the left and right sides and at least partially contained within the cavity; and
a generally ovoid-shaped elastomeric cover substantially covering the exterior surface having a Shore A hardness of between 0 and 10 and having at least one fingertip-sized indentation on at least one of the left and right side of the device generally proximate a front end thereof, the elastomeric cover further having an average thickness of at least 10 mm.

18. The handheld massage device of claim 17, wherein the at least one fingertip-sized indentation includes a left indentation and a right indentation.

19. A handheld massage device consisting of:
a substantially rigid body having an exterior surface and forming a cavity with an interior surface, the cavity having opposing left and right sides;
a wheel, the wheel rotatably coupled to the left and right sides and at least partially contained within the cavity; and
a generally ovoid elastomeric cover substantially covering the exterior surface having a Shore A hardness of between 0 and 10 and having at least one fingertip-sized indentation on at least one of the left and right side of the device generally proximate a front end thereof, the elastomeric cover further having an average thickness of at least 10 mm;
wherein (i) an axle protrusion extends from each of the left and right sides and are received in an axle bore of the wheel; (ii) the body further includes a flange extending around the exterior surface proximate a bottom edge of the cavity, the flange including a plurality of holes distributed thereon; and (iii) the wheel includes a circumferential surface, the circumferential surface including a plurality of hemispherical nubbins distributed there around.

20. The handheld massager of claim 19, wherein elastomeric cover is comprised of thermoplastic polyurethane.
